(19) United States
(12) Patent Application Publication
(10) Pub. No.: US 2026/0356513 A1
(43) Pub. Date: Nov. 12, 2026

(54) System and Methods for the Delivery of Payloads with Horizontal Take-off and Vertical Landing Unmanned Aerial Vehicles

(71) Applicants: Hugues Wanlin, Canmore (CA); Matthew Gowanlock, Canmore (CA); Andrew Hicks, Canmore (CA)

(72) Inventors: Hugues Wanlin, Canmore (CA); Matthew Gowanlock, Canmore (CA); Andrew Hicks, Canmore (CA)

(21) Appl. No.: 19/515,337

(22) PCT Filed: Aug. 29, 2024
(86) PCT No.: PCT/CA2024/051119

§ 371 Date: Feb. 27, 2026

Related U.S. Application Data
(60) Provisional application No. 63/535,482, filed on Aug. 30, 2023.

(51) Int. Cl. B64U 50/18; A62C 3/02; B64U 10/20; B64U 50/12; B64U 70/70; B64U 101/47

(52) U.S. Cl. CPC B64U 50/18; B64U 10/20; B64U 50/12; B64U 70/70; A62C 3/0228; B64U 2101/47

(57) ABSTRACT

Systems and methods for the delivery of payloads to a destination are described utilizing horizontal take-off and vertical landing unmanned aerial vehicles (UAVs). The systems and methods described are particularly suited for delivery of liquid payloads to a fire including wildfires. The UAVs include a thrust propulsion system including a wing tip nozzle (WTN) configured to a wing tip of each wing of the UAV, with each WTN rotatable between a horizontal thrust position and a vertical thrust.

### FIELD

Systems and methods for the delivery of payloads to a destination are described utilizing horizontal take-off and vertical landing unmanned aerial vehicles (UAVs). The systems and methods described are particularly suited for delivery of liquid payloads to a fire including wildfires.

### BACKGROUND

Wildfires are often a major problem in many places around the world. Each year, millions of acres of land burn, which requires enormous and costly efforts to control these fires and reduce or minimize damage to human infrastructure. Wildfires may start naturally or may be accidentally or purposefully started by humans. While fires can be part of the normal fire cycle within forests and grasslands, fires occurring near human infrastructure often cause enormous costs to be incurred. These costs include direct fire suppression costs to control and protect humans and human infrastructure but also the costs resulting from the impact fires can have on the lives of people. These include the risk of injury, personal property damage and economic losses associated with the disruption to people's lives.

Wildfires present many challenges in their management given the complexity of variables associated with wildfires. Such variables can include the number of fires in a region, remoteness, terrain involved, vegetation, current and projected weather conditions, resource availability, and many other variables.

Given the impact of wildfires, governments and associated agencies will take all steps available to them to manage wildfires in a given season, hiring thousands of personnel and mobilizing many resources to manage what can be a highly challenging and complex series of problems across a region.

Given the number of variables involved, this often requires that decision makers triage possible outcomes within an area through a combination of risk assessment and risk management over the course of a fire season.

The resources involved in fighting wildfires are numerous and typically involve the use of land-based and aerial-based equipment. Aerial equipment is deployed to fires when the location, size, speed of progression and proximity to infrastructure and people of the fire suggests that use of these forms of equipment will be effective. The use of aerial-borne water and fire-suppression agents can be a highly effective means of containing, suppressing and/or extinguishing many fires. Typically, aerial carriers including water-bombers and helicopters are an effective means of delivering large volumes of water to a fire particularly if ground routes to the fire do not exist and/or time-considerations are critical.

However, such aerial carriers are enormously expensive, costing thousands to tens-of-thousands of dollars per hour to operate. While the costs of these fire-suppressing aircraft are typical for aviation and generally are not more expensive than in other areas of aviation, given the number of aircraft required and the time they may be required for, the overall costs of fighting a fire can be very high. As is known, the costs of such aircraft include capital costs, maintenance costs, personnel costs and fuel costs required to run aircraft. As known, such aircraft are easily each worth over $1M and can be worth up to $30M+ for the two main types of aircraft used in firefighting.

Water-bombers are specialized aircraft that are designed to efficiently collect and deploy water to a fire. They are advantaged by the high volume of water that can be carried, their speed, their range and the relatively efficient cost/gallon (liter) of water delivered. They are disadvantaged by the need for the availability of nearby water bodies that are sufficiently large to enable the collection of water and safely take off, by their operational envelop in terms of times they can be operated, high capital and maintenance costs, and the need for specialized, highly trained personnel.

Helicopters are advantaged by their ability to take-off vertically, their ability to access water sources not available to water-bombers and their superior ability to target areas with greater precision than can be achieved by water bombers in various situations. They are disadvantaged by their relatively expense cost/gallon (liter) of water delivered, high capital and maintenance costs, range, speed, smaller operational envelop and the need for specialized, highly trained personnel.

Given the high costs of these aircraft, there is inherently a limit on the number of aircraft that may be available in a given region at a given time.

Urban fires are also an important and costly type of fire. Firefighting within an urban area is usually well managed with jurisdictions having multi-faceted fire-fighting forces in permanent operation. However, within an urban environment, aerial attack of residential, commercial and/or industrial fires is typically not a cost-effective approach given the high infrastructure and operational costs of aerial vehicles. However, in many areas if the cost of aerial delivery of water to fight an urban fire was available, aerial attack of an urban fiber could be desirable in a number of situations.

### SUMMARY

In accordance with various embodiments of the disclosure, components of a payload delivery system that may be a firefighting system (FFS) are described. Generally, these components include unmanned aerial vehicles (UAVs), launch and landing systems (LLS) and operational and support systems (OCSS).

In a first aspect, an unmanned aerial vehicle (UAV) is described comprising: a fuselage; 4 wings configured to the fuselage; a thrust propulsion system including a wing tip nozzle (WTN) configured to a wing tip of each wing, each WTN rotatable between a horizontal thrust position and a vertical thrust position; at least one engine configured to the fuselage, the engine having a rotor configured to draw air through a stator and into the fuselage; a wing duct configured to each wing to direct air within the fuselage to each WTN; a throttle system configured within each wing duct to control flow of air through each wing; a payload system configured to the fuselage and to hold a payload; and, a control system configured to each WTN and the throttle system and configured to control flow of air through each wing and orient each WTN.

In various embodiments:
the UAV and control system are configured for horizontal/inclined take-off, horizontal flight and vertical landing.
the control system is configured to independently control the flow of air through each wing and independently orient each WTN.
the payload system is a tank configured to hold a liquid payload.
the payload system is a payload wing configured to hold and release the payload, and to provide aerodynamic lift during flight.
the payload system has a dump valve configured to the control system to enable rapid release of the payload.
the payload system is configured to hold a total mass of liquid payload 2-4 times the mass of the UAV without the payload.
the at least one engine is an internal combustion engine (ICE) having a rotating shaft mounted vertically within the UAV and wherein the ICE drives the rotor without a gearbox.
the at least one engine is a turbine engine.
each wing tip nozzle includes a wing tip actuator configured to independently rotate and control an orientation of each wing tip nozzle.
the UAV includes a control system configured for semi-autonomous control of the UAV.
the UAV control system is configured for multiple phases of flight including:
   take-off phase flight where the UAV control system is configured to orient the thrust propulsion system to a take-off configuration and provide take-off thrust to the thrust propulsion system;
   climb phase flight where the UAV control system is configured to orient the thrust propulsion system to a climb configuration and maintain climb phase thrust and climb phase pitch, roll and yaw control;
   cruise phase flight where the UAV control system is configured to orient the thrust propulsion system to a cruise configuration and maintain cruise phase thrust and cruise phase pitch, roll and yaw control;
   descent phase flight where the UAV control system is configured to orient the thrust propulsion system to a descent configuration and maintain phase thrust and descent phase pitch, roll and yaw control;
   landing descent phase flight where the UAV control system is configured to orient the thrust propulsion system to a vertical landing configuration and maintain landing phase thrust and landing phase pitch, roll and yaw control to land the UAV vertically.
the thrust propulsion system further comprises at least one fuselage mounted nozzle system configured to provide horizontal and vertical thrust.
each WTN includes a landing leg configured to support the UAV on the ground when the WTN is in the vertical thrust position.

In another aspect, an unmanned aerial vehicle (UAV) and launch system is described comprising:
an unmanned aerial vehicle (UAV) having a UAV control system, fuselage and at least 4 vectored thrust propulsion systems configured to wings of the UAV for providing vehicle propulsion and flight control, the thrust propulsion systems configured to rotate to provide a combination of horizontal and vertical thrust during multiple flight phases under control of the UAV control system;
a launch system configured to operatively connect to the UAV during a launch phase, the launch system including at least one rail and acceleration system configured to horizontally accelerate the UAV to a take-off velocity;
wherein the UAV control system is configured for multiple phases of flight including: take-off phase flight where the UAV control system is configured to orient the thrust propulsion system to a take-off configuration and provide take-off thrust to the thrust propulsion system;
climb phase flight where the UAV control system is configured to orient the thrust propulsion system to a climb configuration and maintain climb phase thrust and climb phase pitch, roll and yaw control;
cruise phase flight where the UAV control system is configured to orient the thrust propulsion system to a cruise configuration and maintain cruise phase thrust and cruise phase pitch, roll and yaw control;
descent phase flight where the UAV control system is configured to orient the thrust propulsion system to a descent configuration and maintain descent phase thrust and descent phase pitch, roll and yaw control;
landing descent phase flight where the UAV control system is configured to orient the thrust propulsion system to a vertical landing configuration and maintain landing phase thrust and landing phase pitch, roll and yaw control to land the UAV vertically.

In various embodiments:
the UAV further comprises a payload system configured to hold a payload.
the payload system has an external surface configured as a wing lifting surface providing vertical lift to the UAV during horizontal flight.
the system includes an operations control and support system (OCSS), the OCSS including at least one landing pad, a fuel system, a payload loading system, and a flight center wherein the landing pad is configured to enable UAV landing adjacent the launch system, the fuel system is configured to enable UAV fueling on a landing pad, the payload loading system is configured to enable payload loading to the payload system and the flight center is configured to enable an operator to communicate with at least one UAV during UAV launch, flight and landing.
the payload system includes a dump valve or dump door configured to the control system to enable rapid release of a liquid payload.
the payload system is configured to hold a total mass of a liquid payload 2-4 times the mass of the UAV without payload.

In another aspect, a launch and landing system (LLS) for launching and landing multiple UAVs is described comprising:
a launch system configured to operatively connect to a UAV during a launch phase, the launch system including at least one rail and acceleration system configured to horizontally accelerate the UAV to a take-off velocity;
a landing pad configured to enable a UAV to land vertically adjacent the launch system and configured to the launch system via a track system to enable a UAV to be moved to a launch position on the launch system.

In various embodiments:
the launch system has a frame supporting the at least one rail and acceleration system and a cradle configured to the at least rail and acceleration system for coupling to a UAV during the launch phase.
the LLS includes an operational control and support system (OCSS) for managing launching and landing of multiple unmanned aerial vehicles (UAVs) during UAV mission cycles, the OCSS having an operational flight control system configured to communicate with multiple UAVs during UAV mission cycles.
the LLS includes a reconnaissance UAV configured to monitor a geographic area adjacent a deployment area, the reconnaissance UAV configured to collect situational data from above a deployment area and communicate with the operational flight control system to provide situational data to the operational flight control system.
situational data includes geographic location and local heat signatures.

In another aspect, a fire-fighting system (FFS) for payload delivery to fires is described comprising:
at least one unmanned aerial vehicle (UAV) having at least two wing pairs configured for horizontal or inclined take-off, horizontal flight, vertical landing and payload delivery;
a launch system configured to detachably couple to a UAV and accelerate the UAV to a launch velocity along a track;
a landing pad adjacent the launch system configured to enable vertical landing of at least one UAV;
a payload loading system configured to the FFS to load a payload to the UAV;
a command system configured to launch a UAV from the launch system, monitor a UAV during flight and land a UAV at the landing pad.

In various embodiments,
a fuel loading system is configured to the FFA to refuel a UAV.
a reconnaissance drone is configured to fly in area over a fire, monitor the status of the wildfire and provide real-time information to the command system and wherein the command system is further configured to receive real-time data from the reconnaissance drone.

In yet another aspect, an unmanned aerial vehicle (UAV) is described comprising:
a fuselage;
4 wings configured to the fuselage;
at least two vectored thrust nozzles (VTN) configured to the fuselage, each VTN rotatable between a horizontal thrust position and a vertical thrust position;
at least one engine configured to the fuselage, the engine having a rotor configured to draw air through a stator and into the fuselage;
a duct configured to direct air within the fuselage to each VTN;
a throttle system configured to the duct to control flow of air through each VTN;
a liquid payload system configured to the fuselage; and,
a control system configured to each VTN and the throttle system and configured to control flow of air to each VTN and to release liquid payload from the liquid payload system.

In one embodiment, the UAV includes at least two wing tip nozzles (WTNs) configured to a wing tip of each wing, each WTN rotatable between a horizontal thrust position and a vertical thrust position.

### BRIEF DESCRIPTION OF THE DRAWINGS

With reference to the drawings, embodiments of unmanned aerial vehicles, (UAVs) configured for horizontal take-off and vertical landing together with associated launch, landing, loading and control systems are described in which:

FIG. 1 is a plan view of an unmanned aerial vehicle (UAV) and launch and landing system (LLS) in accordance with one embodiment of the disclosure.

FIG. 2 is a schematic plan view of a wildfire operations center configured to launch, land and control multiple UAVs in accordance with one embodiment of the disclosure.

FIG. 3 is a side view of a launch system in accordance with one embodiment of the disclosure.

FIG. 4 is a plan view of a wildfire operation showing multiple UAVs flying missions to a wildfire and an operations center in accordance with one embodiment of the disclosure.

FIG. 5 is a bottom view of an unmanned aerial vehicle (UAV) in accordance with one embodiment of the disclosure.

FIG. 6 is a top view of an unmanned aerial vehicle (UAV) in accordance with one embodiment of the disclosure.

FIG. 7 is a front view of unmanned aerial vehicle (UAV) in accordance with one embodiment of the disclosure.

FIGS. 8-10 are front, rear and lower isometric views of an unmanned aerial vehicle (UAV) in accordance with one embodiment of the disclosure.

FIG. 11 is a partial cross-sectional view of the fuselage and thrust system of an unmanned aerial vehicle (UAV) in accordance with one embodiment of the disclosure.

FIGS. 12-15 are partial cross-sectional views of a wing throttle of an unmanned aerial vehicle (UAV) in open and closed positions in accordance with one embodiment of the disclosure.

FIGS. 16-17 are side views of a wing-tip nozzle actuation system of a UAV in accordance with one embodiment of the disclosure.

FIG. 18 illustrates a control system of a UAV in accordance with one embodiment of the disclosure.

FIG. 19 is a schematic view of airflow through a UAV in accordance with one embodiment of the disclosure.

FIGS. 20-23 are schematic views showing the position and operation of landing nozzles in accordance with one embodiment of the disclosure.

FIGS. 24 and 25 are schematic diagrams of a floating launch and landing system in accordance with one embodiment of the disclosure.

FIGS. 26-29 are lower and upper isometric and side views of an alternate UAV design having wing tip nozzles and vectored thrust nozzles shown in horizontal and vertical thrust positions.

### DETAILED DESCRIPTION

Within the disclosure and with reference to the drawings, the following are described:
a. Unmanned aerial vehicles (UAVs) configured for horizontal or inclined take-off and vertical landing and associated launch, landing, loading and control systems.
b. UAVs configured to deliver payloads that are launched horizontally or inclined and land vertically.
c. Systems for airborne delivery of liquid payloads, including water to fires.
d. Systems for launching, landing and controlling multiple UAVs in the delivery of liquid payloads to fires.

Generally, within this description, horizontal flight is defined as flight when the UAV wings are providing substantial lift whereas vertical flight is defined as flight when the UAV wings are not providing substantial lift and the engine(s) alone is/are providing vertical thrust to maintain lift.

### Overview

Within this description and with reference to the figures, various embodiments of UAVs, launch and landing systems (LLSs) and operational control and support systems (OCSSs) are described. Collectively, UAVs, the LLS and the OCSS are referred to as a fire-fighting system (FFS).

For the purposes of initial description, the FFS and the component UAVs, LLS and OCSS are described with reference to a deployment scenario, namely the delivery of liquid payload to a wildfire. While the FFS is described as system for fighting wildfires, and is described as being portable, it is understood that the FFS can also be designed as permanent or semi-permanent installation. Within this description, a mission is a UAV flight cycle including various mission phases including UAV preparation, UAV launch, outbound flight, inbound flight and landing.

In a wildfire deployment scenario, a wildfire has ignited in remote hills and is burning towards an inhabited area. The area near the fire has road access to within 20 km of the fire front and a lake water source approximately 100 m from a relatively flat and cleared area about 100 m long and 50 m wide. Local authorities have decided to deploy a FFS to this area to fight the fire.

Generally, each of the various sub-systems of the FFS are designed to be transportable to an operations site close to the wildfire and deployed such that the LLS and OCSS can be set-up and thereafter enable multiple UAVs to be launched, deliver a payload, return to the OCSS, be reloaded with new payload and relaunched. As described herein, each UAV is configured for horizontal take-off and vertical landing via the LLS with the UAV in horizontal flight between launch and landing. As will be explained in greater detail below, this configuration enables a relatively high take-off weight and low landing weight and also enable rapid turnaround of UAVs for repetitive flight missions and the delivery of significant volumes of liquid payload to a fire with each mission.

### UAV Design

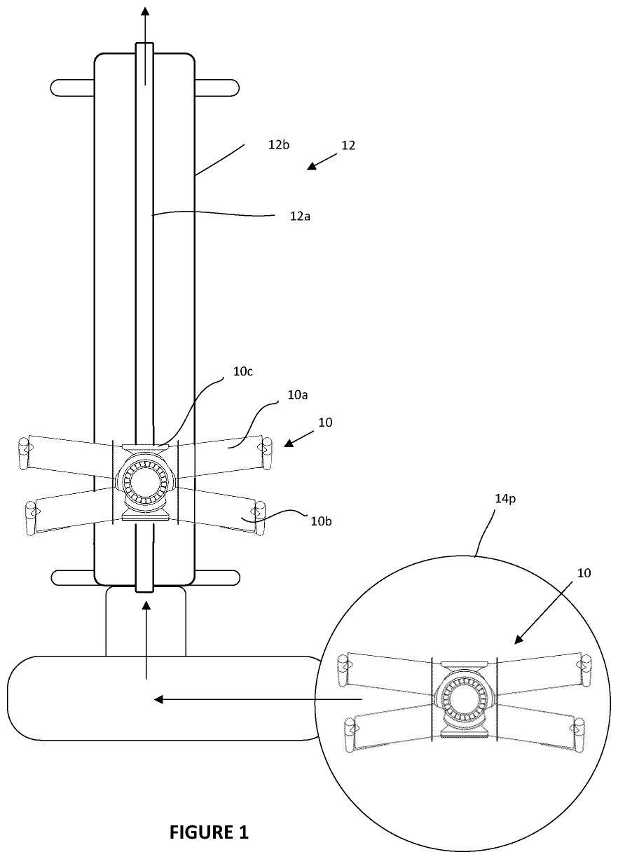

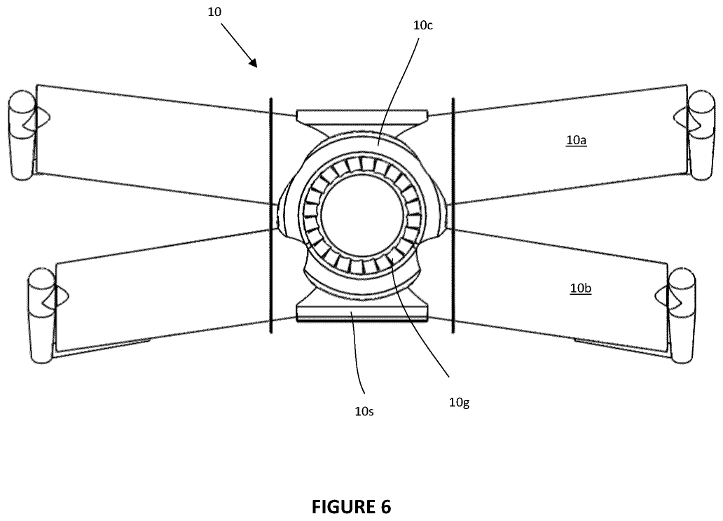

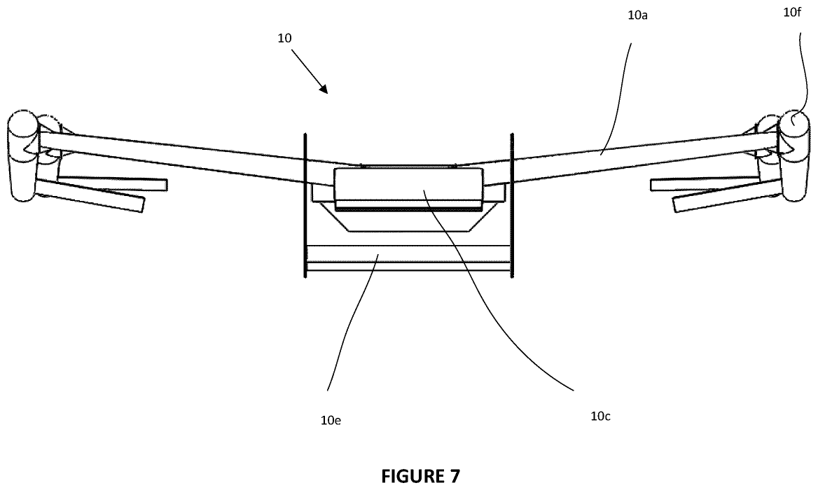

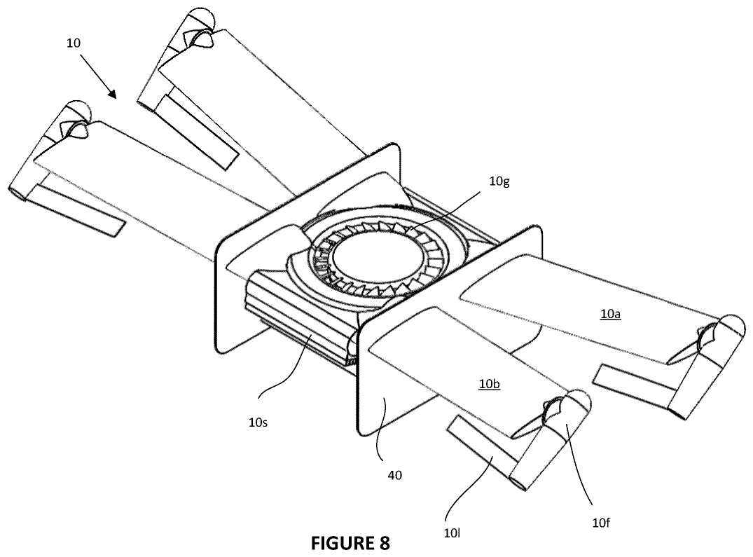

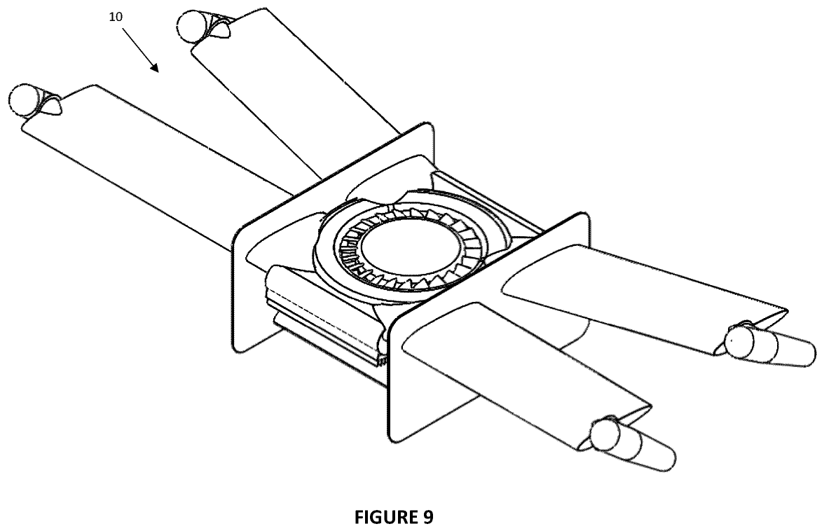

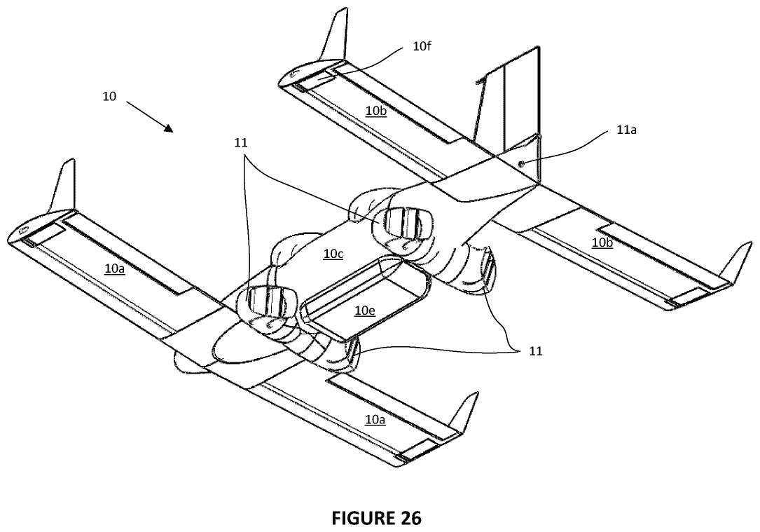

As shown in FIGS. 1-11, and FIGS. 26-29 for the purposes of general description, the UAV 10 is a multi-winged aircraft having two main wing pairs 10a, 10b configured to a fuselage 10c containing at least one engine 10d (generally referred to herein in the singular), control electronics and fuel. In one embodiment, a payload tank/wing 10e is configured beneath the fuselage to provide lift during horizontal flight and to hold a payload such as a liquid payload. In other embodiments, the payload tank is configured within or beneath the fuselage 10c as shown in FIG. 26 or within the wings. The UAV is also configured with a landing system such as a landing skid 40 or other system configured to support the UAV on the ground.

In one embodiment, the UAV includes 4 wing tip nozzles (WTNs) 10f configured to the two main wing pairs at or towards the outboard tips of each wing, the WTNs rotatable to provide both horizontal and vertical thrust during the different phases of flight during a mission. In one embodiment, two or more vectored thrust nozzles (VTNs) 11 are configured to the fuselage that are rotatable to provide both horizontal and vertical thrust during the different phases of flight during a mission. Each engine 10d is configured with at least one high efficiency fan rotor 10g which during operation draws air into a stator 10h which is then directed to each of the WTNs at high velocity through the wings and/or the VTNs. The air flow to the WTNs and VTNs is controlled via a throttle system (described below) and the orientation of the WTNs and VTNs (described below) can be adjusted to collectively provide control to the wing tips including thrust and thrust direction which enables full control over pitch, roll and yaw of the UAV.

In various embodiments, the UAV is designed to hold approximately 200-1000 liters of water in the tank 10e and deliver this volume of water to a target fire during one mission cycle. The approximate empty weight of the UAV may be approximately 100-400 kg, thus having a total take-off weight of approximately 300-1400 kg depending on fuel and payload loading.

### Launch and Landing System (LLS) 12

To achieve rapid horizontal take-off with a 300-1400 kg take-off weight and minimize the operational footprint of a FFS deployment, the system includes a launcher and landing system (LLS) 12. As shown in FIGS. 1-3, the LLS includes a launcher 12b configured as a ramp having a track 12a which is used to rapidly accelerate a UAV to take-off velocity along a horizontal or inclined axis.

The LLS further includes one or more landing pads 14p where a UAV may land vertically adjacent to the launcher. The LLS may also include one or more pathways configured between a landing pad and the launcher to facilitate movement of a UAV onto the launcher.

### Operations Control and Support System (OCSS) 14

An OCCS 14 is described in the context of a typical deployment where multiple UAVs are being repetitively launched to complete multiple water-delivery missions to a wildfire approximately 10-20 km from the OCSS.

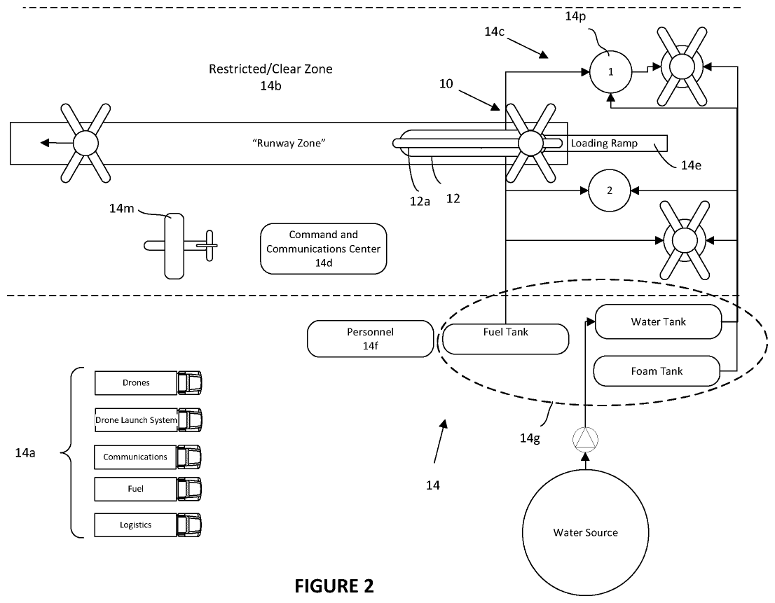

In this representative example, the OCSS is established at the desired location as shown in FIG. 2, where within an area of land, vehicles 14a deliver system equipment to the area which is set-up as a mini air base. The OCSS is divided into zones including a flight/restricted zone 14b, a landing zone 14c, a command center 14d, a loading zone 14e, personnel center 14f, and storage areas 14g.

Flight zone 14b is established with sufficient consideration to local geography and weather conditions to ensure safe UAV operation within the known flight envelop of the UAVs. That is, the OCCS and the positioning of the LLS will consider local variables such as trees, hills, man-made structures, altitude, air density as well as local weather conditions in establishing an appropriate location for the OCSS.

As such, flight zone 14b will be selected to have sufficient length and position to provide clearance over natural hazards and avoid or take advantage where possible of prevailing/current wind and weather conditions. The launcher is preferably positioned and oriented in the flight area facing the wind.

When the OCSS and LLS have been set up, UAVs 10 are moved to positions around or within the LLS (e.g., landing pads 14p) where they can be repetitively prepared for flight which primarily includes payload loading and fueling.

### Mission Flight Phases

### 1. Launch

Under control or direction of the command center 14d, UAVs are prepared for launch from launcher 12. Depending on configuration, UAVs may be lifted to the launcher pre- or post-fuel/payload loading. In either case, upon loading to the launcher, the UAV is configured to launch track 12a via a cradle 12j. The UAV engine 12d is throttled up and the WTNs and/or VTNs oriented to a take-off configuration (i.e., aft facing). Upon take-off thrust being reached, the launcher rapidly accelerates the UAV along the launcher track. In a typical design, the UAV will be rapidly accelerated to a take-off velocity of approximately 20 m/s or 40 knots indicated air speed (IAS) by the time the UAV reaches the end of the launcher at which point it disengages with the track and cradle and begins aerial horizontal flight.

The launch cradle is decelerated and returned to the launch position for the next launch sequence.

Control for all phases of launch, flight and landing may be manual, autonomous or semi-autonomous as will be explained below.

### 2. Climb and Cruise Phase

The UAV will continue to accelerate and climb away from the launcher in a climb phase typically under maximum aft thrust. Climb phase to a few hundred feet may take about 1 minute.

Upon reaching cruising altitude, the engine will typically throttle back to enter a cruise phase (typically about 70% power) and may now be cruising at about 50 m/s (90-100 knots) IAS. The UAV may cruise at a few hundred feet above the ground for the duration of the mission depending on local conditions and requirements. Generally, as missions are relatively short and will typically deploy payload at a relatively low altitude, the UAVs will remain relatively close to the ground to minimize flight time and fuel consumption. Low altitude procedures help to ensure greater accuracy for payload delivery but must also take into account the effects of ambient weather conditions, smoke, wind direction, fire intensity, and other factors that firefighters must consider.

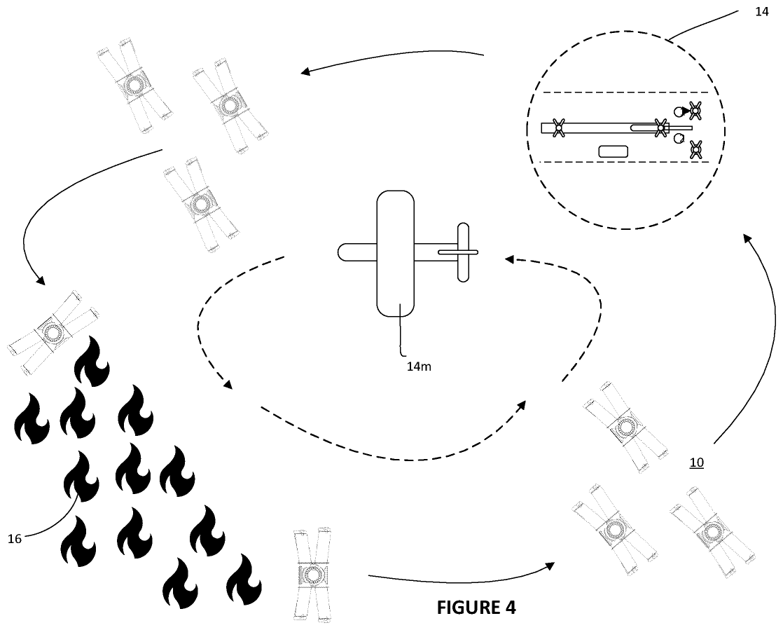

Under automatic or ground-based control, the UAV is directed to wildfire 16 (FIG. 4). If the wildfire is 10-20 km away, flight time to the drop zone will typically be approximately 3-7 minutes.

### 3. Payload Delivery and Return

Upon reaching a drop zone, the UAV is commanded to drop its payload at the wildfire 16. Payload delivery will typically be rapid and may include opening tank doors on the underside of the payload tank.

Upon payload delivery, the UAV begins to return to the OCSS. With the weight of the UAV substantially decreased, return speed may be higher and/or thrust may be reduced having consideration to the overall parameters of the mission.

### 4. Descent and Landing Phase

Upon approach to the OCSS, the UAV will enter a descent phase leading to a vertical landing with the landing zone 14c. The horizontal and vertical speed of the UAV is controlled by wing nozzle and/or VTN vectoring and UAV drag. Descent phase and landing may take approximately 1-2 minutes.

In various configurations, the UAV is directed to land at a precise landing point behind the launcher. Such landing may be configured such that pinpoint landing at landing pads 14p is controlled based on known global navigation satellite system (GNSS) (e.g. GPS) positions of the landing pads 14p and/or beacon signals originating from the landing pads.

Upon having its landing point determined, as part of the descent and landing phase, the UAV will rotate the WTNs/VTNs to deliver vertical thrust in order to transition from horizontal flight to vertical flight such that the UAV lands vertically on its landing pad. At the point of touch down, the UAV will be delivering vertical thrust substantially equal to its touch down weight.

Landing will typically require the engine to throttle up to provide a maximum landing thrust.

Upon touch down the UAV will typically shut down its engine and/or throttle down air flow to the WTNs/VTNs.

### Reloading

Upon landing and/or shutdown, the UAV will be prepared for its next mission, which will include payload loading and refueling as may be necessary. The LLS will preferably be configured with appropriate piping to enable payload and fuel loading with the UAV on its landing pad or in a pre-launch zone via fuel, water and/or other payload storage tanks (e.g. foam fire retardant). After a UAV has been reloaded to the launcher, a mission cycle can be repeated. Multiple UAVs may be fully fueled and loaded with payload and be positioned immediately behind a UAV on the LLS. In this case, a blast fence 120 may be raised/lowered/rotated into a position to protect equipment down range of the LLS.

### Operational and Mission Cycle Parameters

In a typical deployment scenario, multiple UAVs will be successively launched as rapidly as can be operationally accomplished. It should be noted that the figures in the following paragraphs are merely intended to be illustrative and depending on the configuration of the FFS, UAVs, LLS and OCSS may enable more rapid deployments than the numbers discussed below.

In a typical scenario, a complete mission cycle for one UAV may include 3-5 minutes loading time to the launcher, 5-20 minutes of flight time including launch, climb, cruise, payload deliver, return, descent and landing phases of flight, 5 minutes of refueling/reloading resulting in a total mission cycle of 15-30 minutes. Accordingly, conservatively, a UAV may complete 2-4+ missions per hour such that a single UAV may be able to deliver 400-4000+ liters per hour of water to the wildfire. Overlap and excess UAVs in the line-up may enable UAVs to be launched more rapidly thus providing higher payload delivery rates.

If the total time to lift a UAV to the launcher and launch the UAV is 5-7 minutes, a single launcher can launch 8-12 UAVs per hour thus delivering 1600-12000 liters/hour of payload to the wildfire. This can be accomplished using as few as 4-6 UAVs.

If the launch time is decreased to 60-90 seconds per UAV, 20-30 UAVs can be launched per hour delivering 4000-30000 liters of payload per hour to the wildfire.

The concurrent deployment of multiple launchers can proportionally increase the payload delivery.

As the UAVs are unmanned, the UAVs will be less limited than piloted aircraft in terms of time-of-day operations and potential weather scenarios.

That is, in comparison to water bombers and helicopters, water bombers and helicopters often cannot be safely operated at night to fight the fire primarily for safety considerations for the equipment and pilots.

With UAVs of the FFS being unmanned and substantially lighter and under autonomous or semi-autonomous control, the daily operations window may be substantially continuous if conditions permit. If the FFS can be operated continuously, this may provide clear advantages in suppressing and extinguishing a fire, particularly as local winds often diminish at night meaning that more effective fire suppression by aerial bombardment may be realized at this time of day.

Further, while crashing a UAV is never desirable, the effect of a crash would be substantially lower compared to a piloted aircraft as no human pilots would be involved and the capital loss as a result of a crash would be substantially lower. Moreover, as a UAV will carry a substantially smaller fuel load compared to a helicopter or water bomber, the fire risk of a crashed UAV may be substantially smaller. Various safety considerations that could further mitigate risks are discussed below.

### UAV Design Specifications

Table 1 illustrates representative specifications of two representative UAVs.
Generally, these specifications are intended to show approximate performance parameters
with it understood that the ultimate design of a UAV could vary significantly from the
figures presented in the table.

| | UAV 1 | UAV 2 |
|---|---|---|
| Parameter | Value | |
| Airframe (unfueled) Weight | 80 kg | 500 kg |
| Wingspan | 5 m | 10 m |
| Main Wing area | 7 m² | 35 m² |
| Payload Wing area | 1 m² | |
| Total Wing Area | 8 m² | |
| Airframe Weight excluding | 60 kg | 300-400 kg |
| Engine and Fuel | | |
| Payload | 200 kg | 800-1000 kg |
| Take-off Weight | 300 kg | 1400+ kg |
| Wing-loading | 300/8 = 37.5 kg/m² | 38 kg/m² |
| Engine Power | 60 hp | 450 hp |
| Engine Weight | 15-20 kg | 100 kg |
| Fuel Weight | 25 kg | 140 kg |
| Take-off Velocity | 20 m/s (40 knots) | 20 m/s (40 knots) |
| Climb Rate | 90 m/min | 90 m/min |
| Climb Speed | 25 m/s | 25 m/s |
| Cruise speed (at 70%) | 40-50 m/s | 40-50 m/s |
| Landing thrust | 120 kg | 500 kg |
| | 4 × 30kg | |
| Fuel Consumption | 20 liters/hour | 140 liters/hour |
| Fuel Load | 15-20 I | 140 I |
| Stall Speed | 33 knots | 33 knots |

### UAV and LLS Design

### 1. Wing, Fuselage and Propulsion Design

In one embodiment, the UAV is a tri-wing aircraft having two wing pairs 10a, 10b and a payload wing 10e. The two wing pairs have first, second, third and fourth wing tips respectively each configured with WTNs 10f that can be rapidly pivoted to provide vertical and horizontal thrust depending on orientation and flight control. Air is ducted into the fuselage 10c by main engine 10d through rotor 10g and stator 10h, into the wings (having wing ducts/conduits 10k) and out to the WTNs10f. Air pressure to the WTNs is controlled by a throttle system 20 configured within each wing such that the velocity/pressure of air from each WTN can be independently controlled.

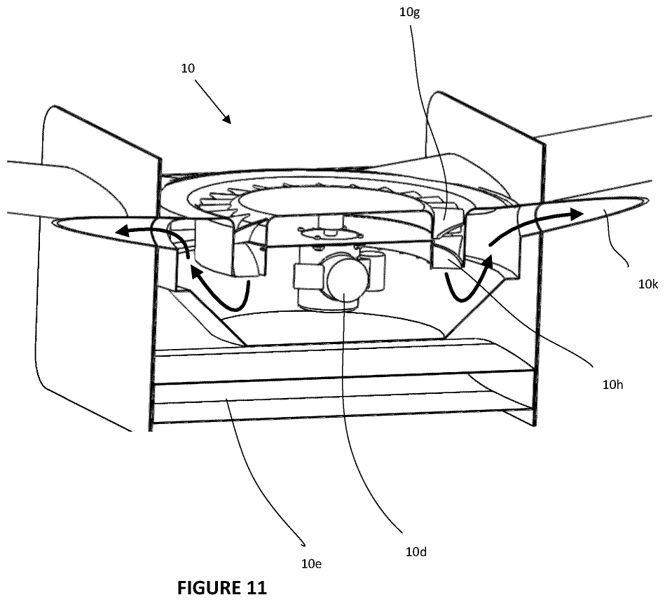

In one embodiment, the engine is an internal combustion engine (e.g., 2 or 4 stroke engine) or gas turbine mounted within the fuselage and connected to the rotor such that the rotor is substantially horizontal with respect to the horizontal axis of the UAV and the ICE has a vertical shaft. The rotor draws air downwardly through the stator creating air pressure within the fuselage which causes flow through wing ducts 10k (FIG. 11) into each WTN 10f.

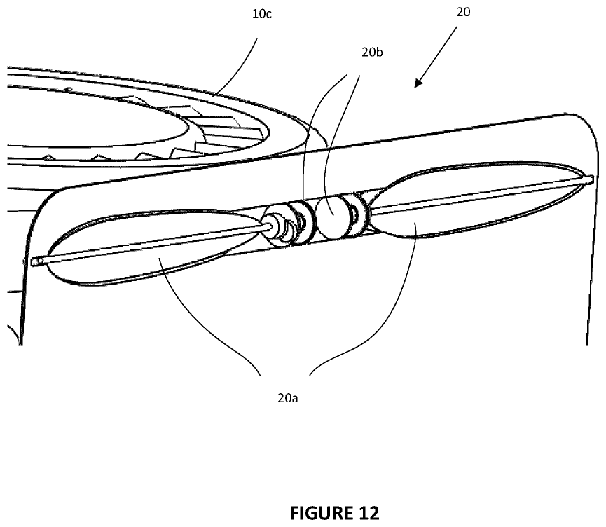

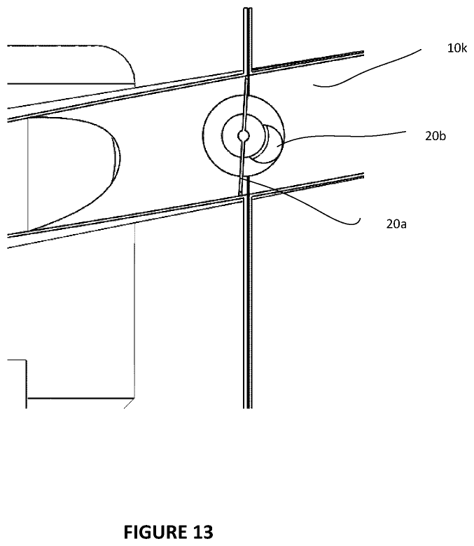

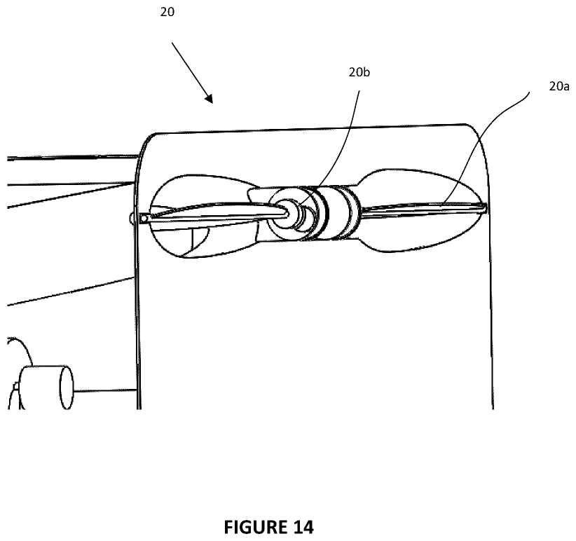

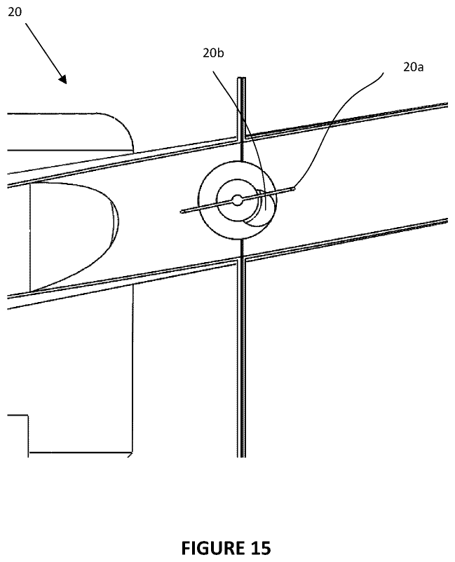

As shown in FIGS. 12-15, each wing is configured with a throttle 20a that is independently controlled to control the pressure/velocity of air being ducted into each wing/WTN. The throttle may be a vane that is pivotally connected to the interior of the wing that may be rotated between a fully open (FIGS. 14 and 15) and fully closed position (FIGS. 12 and 13) under control of a throttle actuator 20b.

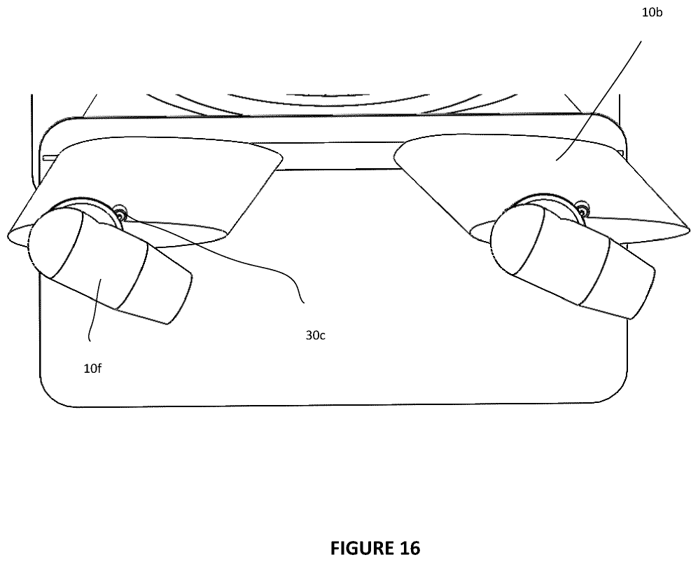

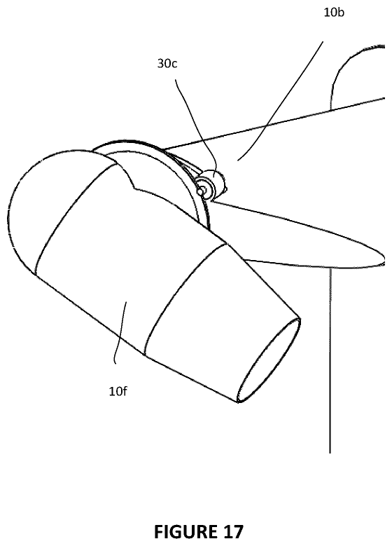

The WTNs are rotatably configured to the wing tips and under the control of nozzle actuators 30c (FIG. 16) that enable the WTNs to rotate relative to a horizontal axis of the UAV. Nozzle actuators and throttle actuators may be servo/step motors with appropriate gearing/drive systems to enable rotational movement of each of WTNs and wing throttles respectively.

Designs having fuselage-mounted vectored thrust nozzles (VTNs) that provide vectored thrust at the fuselage are shown in FIGS. 26-29. In addition, a combination of WTNs and fuselage-mounted nozzles may be utilized in various designs with different proportions of total thrust being directed to the WTNs or VTNs depending on design. Similar throttling and nozzle actuators may be utilized for VTNs.

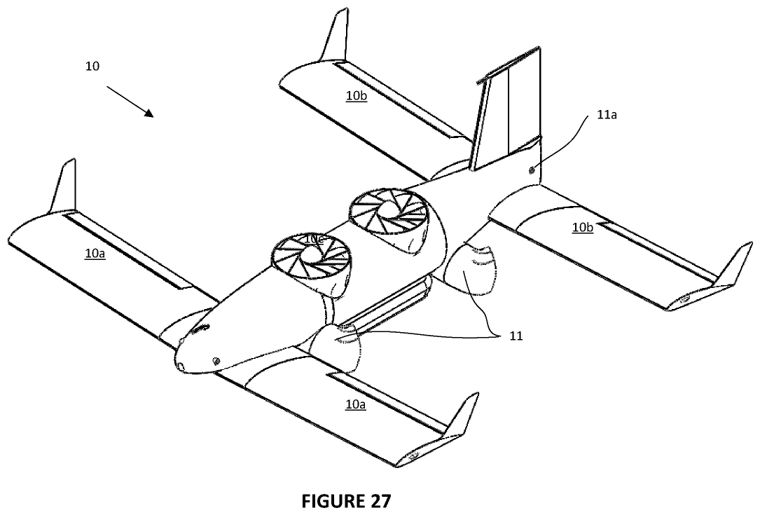

FIGS. 26 and 27 show a UAV having both WTNs and VTNs in a horizontal flight orientation. In this embodiment, the WTNs and VTNs are configured such that the VTNs provide the majority of horizontal and vertical thrust whereas the WTNs provide stability control. As shown in FIGS. 26 and 27, the WTNs are folded into the wings during horizontal flight with flight control being provided by traditional ailerons, flaperons, rudder and elevator surfaces.

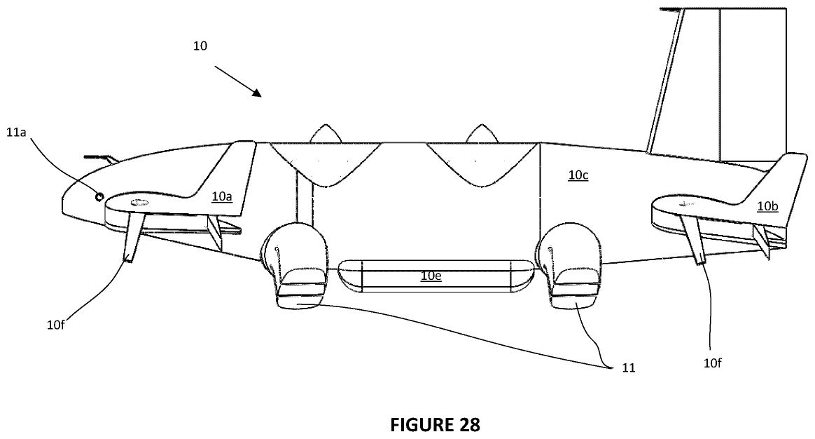

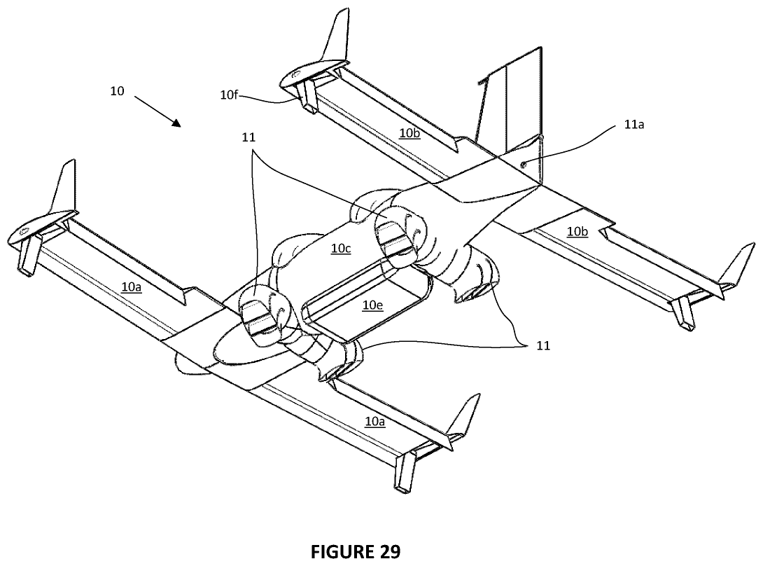

FIGS. 28 and 29 show a UAV having both WTNs and VTNs in a vertical flight orientation. As shown, the WTNs are extended from the wings during vertical flight with flight control being provided by throttled air flow through the WTNs and vertical thrust being provided by the VTNs. In this example, the WTNs may also serve as landing legs. Puffers 11a may also provide additional flight control as required.

### 2. Control System

Appropriate sensors (e.g., gyroscopes, accelerometers, position sensors, etc.) are configured throughout the aircraft to monitor UAV orientation (pitch, roll, yaw) in 3D space, wherein sensor information is utilized by one or more controllers to control the movement of the UAV in 3D space. Such sensors typically include speed, altitude, proximity and Global Navigation Satellite Systems (GNSS) (e.g. GPS) information that may be derived from a plurality of known aircraft/drone sensors.

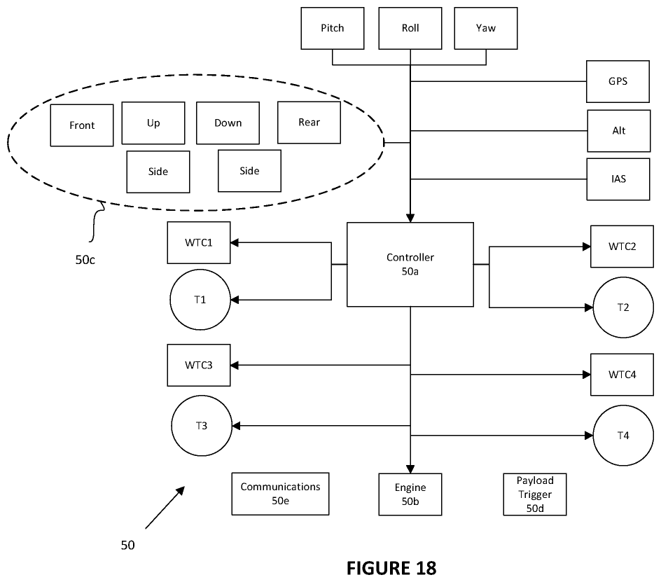

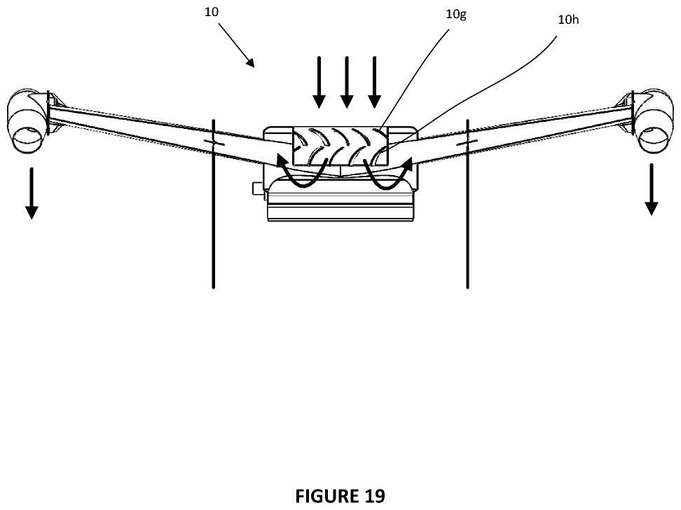

As shown in FIG. 18, the flight control system 50 includes a controller 50a that receives inputs from sensors and provides control instructions to the engine 50b, throttles T1-T4 and wing tip controllers WTC1-WTC4 (and/or vector thrust controllers). Input sensors include one or more gyroscopes and flight orientation sensors such as pitch, roll and yaw accelerometers, GPS sensors for location determination, altimeter and air speed sensors. In addition, the control system may include various collision avoidance sensors 50c such as above, below, side and front and behind sensors using camera/lidar type sensors.

Generally, the UAV may be operated under fully autonomous or partially autonomous control depending on set-up. Take-off, climb, cruise, descent and landing phases of flight will typically be fully autonomous with the UAV receiving flight sensor and GPS information from the sensor systems. Primary commands to initiate flight may be triggered by human input and operators may override autonomous flight control at any time. The UAV will have a communications system 50e enabling communication with other components of the system and/or operators.

Individual programs may be implemented to control each phase of flight such that minimal operator control is required.

For example, upon launch, the UAV may be fully controlled by the UAV control system and will adjust flight controls to maintain the phase of flight. That is, control of pitch, roll and yaw will be controlled by a combination of air velocity/pressure throttling to the wing nozzles and orientation of the WTNs and/or VTNs. For example, pitch may be controlled by respective adjustment of the orientation of the aft nozzles relative to the orientation of the forward nozzles. Pitch-up may be controlled by slight downward movement of the forward nozzles and/or upward movement of the aft nozzles and vice versa for pitch-down. Roll may be controlled by upward and downward movement of starboard vs. port wing nozzles and yaw controlled by relative throttling of starboard vs. port wing thrust. In various designs, pitch and/or yaw control may require puffers 11a (FIGS. 26, 29) configured to appropriate positions on the fuselage or wings that provide controlled bursts of compressed air to provide and/or assist in pitch and/or yaw control.

During climb phase, the engine may be maintained at substantially full power and an appropriate pitch to maintain a desired climb speed.

Upon transitioning to cruise phase, the engine may throttle down with UAV pitch adjusted to cruise pitch. Level flight to desired coordinates may be autonomous or semi-autonomous under sensor input and control. In various scenarios, the control system may throttle off power to a reduced number of WTNs or VTNs such that a lower number of WTNs/VTNs are used for cruise flight.

Upon payload delivery trigger 50d being activated, the payload will be released from the UAV. Payload delivery may occur at cruise speed or slower. Payload delivery will dramatically lower the mass of the aircraft which may cause rapid acceleration of the aircraft and/or altitude gain; thus, simultaneous adjustments may be made by the flight control to maintain controlled flight.

The descent phase will transition the UAV from horizontal to vertical flight. Typically, with a landing coordinate/location known by the UAV, the UAV will determine a waypoint at which the descent phase will initiate to land at a landing waypoint. The UAV will calculate a descent path based on the waypoint and landing coordinates. Upon reaching the waypoint, the descent phase is initiated, and the descent path tracked with appropriate inputs to the wing nozzles and wing throttles (and/or VTNs) together with micro-adjustments to maintain appropriate pitch, roll and yaw of the aircraft. The descent path will include a final vertical flight phase where the UAV will descend vertically to touch down at the landing pad.

One or more operators may control or monitor particular phases of flight depending on the mission parameters that may be determined by human operators and/or by one or more surveillance drones 14m that may provide input to define one or more UAV mission parameters. In one embodiment, an operator will always have the option to take control of a UAV via a ground control system configured to communicate with the UAV via the UAV communication system 50e should the situation require it. Typically, the UAV has the capability to safely operate within a 3D geofence with no operator input.

Furthermore, in a fully operational multi-UAV system, operators are predominantly overseeing the entirety of the FFS deployment and predominantly observing decisions being made by the control system and only making minor adjustments to individual UAV missions based on their experience/observations.

To that extent, a 2+ launcher system may be operating with multiple UAVs (e.g 10 UAVs) with the ground crew and working to launch UAVs as rapidly and as continuously as possible, additional inputs may help to increase system efficiency.

### 3. Other Design Features

In various embodiments, the UAV may also be configured with air control surfaces including ailerons, flaperons, elevator and rudder control surfaces (/FIGS. 26 and 29).

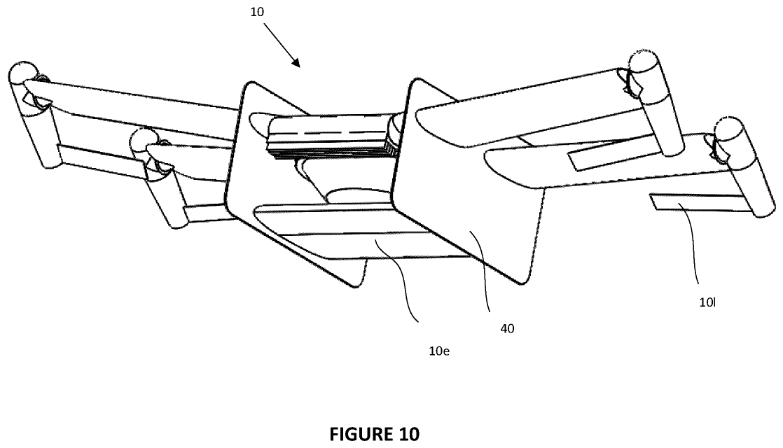

As shown for example in FIG. 10, each WTN may be configured with a landing leg 101 that may provide stability to the UAV as it touches down to reduce the likelihood of the UAV tipping over on the ground. The landing leg may also operate as a flight control surface.

In various embodiments, one or more surveillance drones 14m may be airborne and be surveying the fire area and feeding information back to the operations center. The surveillance drone 14m may be configured with appropriate cameras and sensors to map fire locations, heat signatures and UAV positions as they are flying missions. The information collected from a surveillance drone may be delivered back to the operations center to enable operators and/or mission planning software to design missions for each UAV.

For example, as a fire may be moving, successive missions may be longer or shorter than earlier missions; hence flight times may be longer or shorter with other mission parameters being dynamic. Hence, the system may calculate launch times for subsequent UAVs based on changing parameters. For example, if mission times are becoming longer due to the fire being further away, the FFS may introduce additional UAVs into the launch sequence, such that at any given time more UAVs are in the air. The opposite may be followed should flight times become shorter.

### 4. Safety Features

Safety of FFS personnel and others is desirable within the FFS system. Importantly, by using an engine system to provide power through ducted air pressure/velocity, the UAV eliminates propellers that would create hazards to all ground personnel and others and increase the footprint for a safe deployment. That is, in comparison to a UAV utilizing propellers, the risk to ground personnel operating in an area where there are no exposed propellers is reduced, thus enabling personnel to approach closer to the UAVs during the mission cycle and allow for a substantially more compact operation.

Each UAV may be configured with a ballistic parachute that upon detection of a severe flight anomaly could be rapidly deployed to slow an uncontrolled or unplanned descent of the UAV. This may be particularly desirable in deployment scenarios where the FFS may be operating in closer proximity to inhabited areas. While a parachute may not prevent damage in all crash scenarios, it may substantially reduce the effects of a crash.

In addition, if a UAV has an engine system which is substantially contained within the fuselage, the ability to contain and deploy a parachute without nearby spinning propellers can reduce the size and weight of the parachute system.

Further still, each UAV may contain a relatively small fuel payload, which ideally will be contained with an impact resistant flexible tank that will further minimize the risk of fuel leaks in the event of a catastrophic crash.

Another safety feature may be a siren that provides audio warning of a nearby UAV to persons on the ground.

Another safety feature may be an emergency dump of payload to reduce the weight of the UAV and reduce the kinetic energy of a UAV during a crash. An emergency dump of payload may also provide a UAV with more time to recover from a flight anomaly.

### 5. Payload Tank/Wing

In one embodiment, the payload tank/wing 10e is configured to both hold payload and to provide lift during horizontal flight. In various embodiments, the tank may have an internal volume of about 200-400 liters of water.

### 6. Engine

In various embodiments, two-stroke or four-stroke engines rated for 60-120 hp may be utilized. Such engines having a shaft output speed of 9000-11000 rpm may not require gearing. The size and power of the engine will be selected based on a number of variables including fan impellor/rotor size and other design factors.

Jet turbines rated for 400-500 hp for larger UAVs may also be employed in which case gearboxes may be required to reduce shaft speeds.

The use of multiple engines within the UAV may be desired in various embodiments.

### 7. Launcher

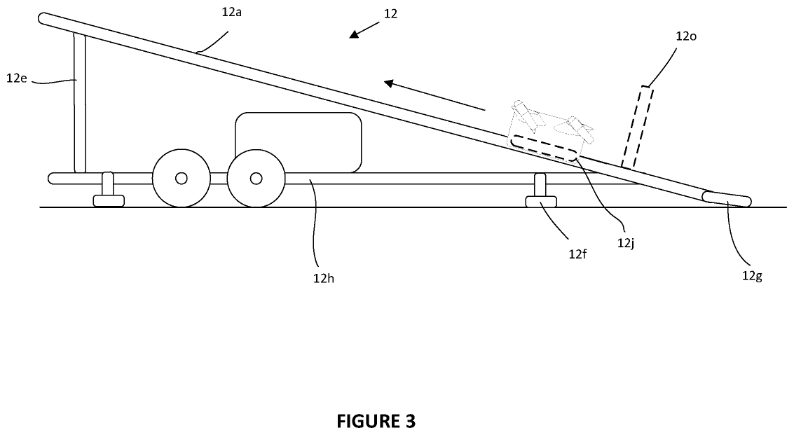

As shown in FIG. 3, the launch system 12b may be a trailer mounted system allowing the launch system to be readily moved to a preferred launch orientation. The launch ramp and track 12a may be supported and orientable via one or more support legs 12e that lift/rotate the launch track to a desired launch angle. The launch system may include other frame components 12h and stabilizing legs 12f. A loading ramp 12g may be deployed to assist loading an UAV 10 into a launch position. The LLS may include a blast fence 12o.

The UAV is configured to a cradle 12j which may be rapidly accelerated under control of a drive system 12i.

### 8. Landing Nozzles

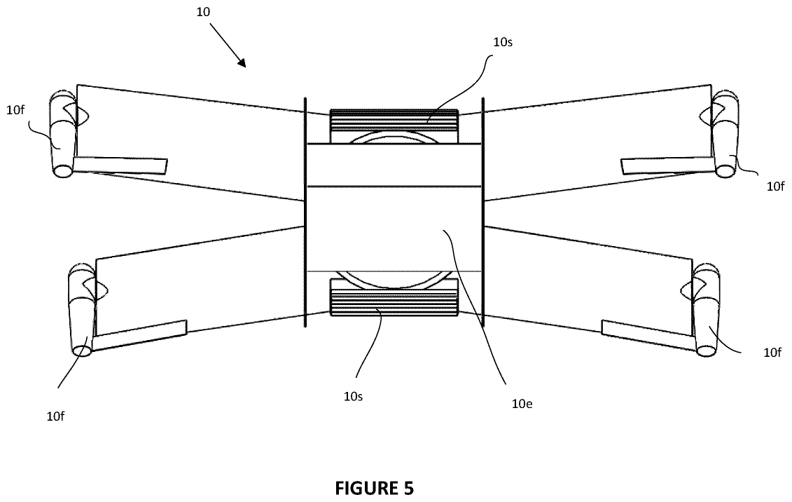

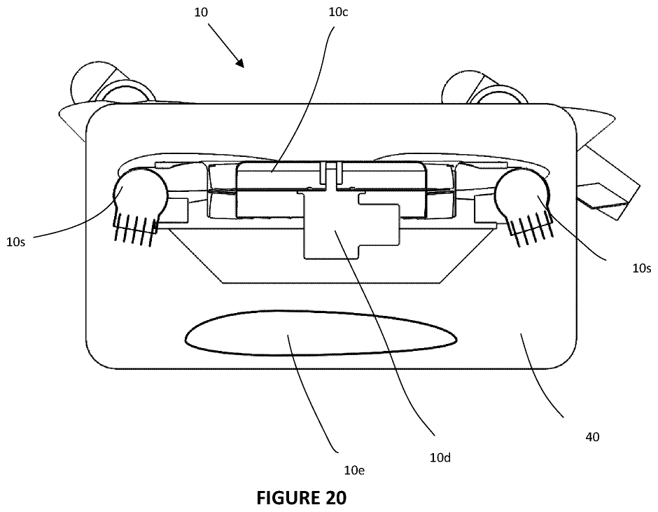

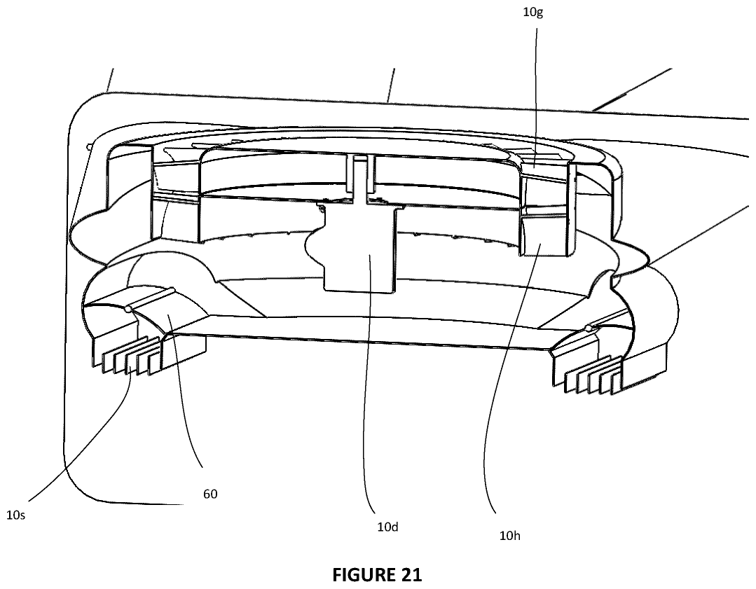

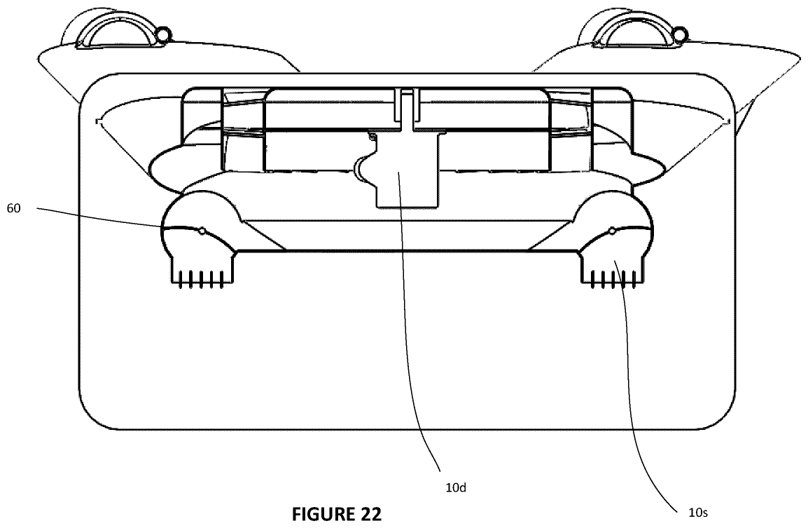

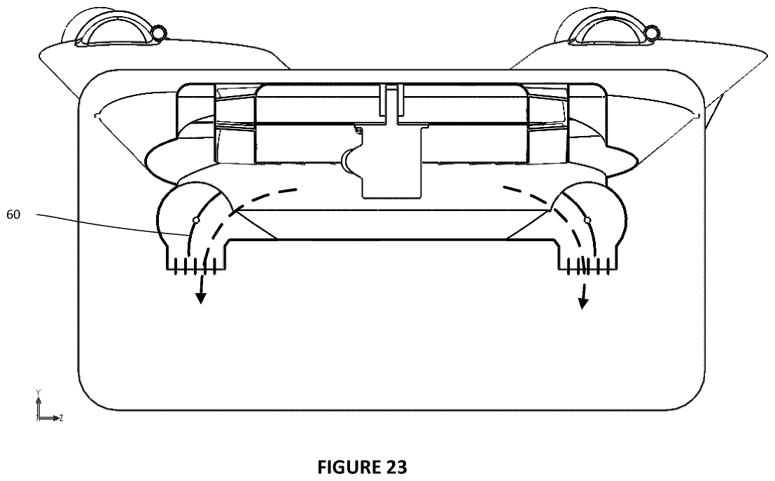

In various embodiments, the UAV includes landing nozzles 10s configured to the fuselage. The landing nozzles provide additional downward thrust during the landing process over a wider surface area that, via the ground effect, assists in controlling landing. As shown in FIG. 5, the landing nozzles may be louvered vents located at the front and rear ends fuselage that may be activated during the landing process. As shown in FIGS. 20-23, the landing nozzles may be configured with landing throttles 60 that are operable between an open and closed position to selectively direct air through the landing nozzles.

In various embodiments, the landing nozzles are moveable VTNs configured to the fuselage.

9. Water-Based Deployment and/or Permanent/Semi-Permanent Deployments

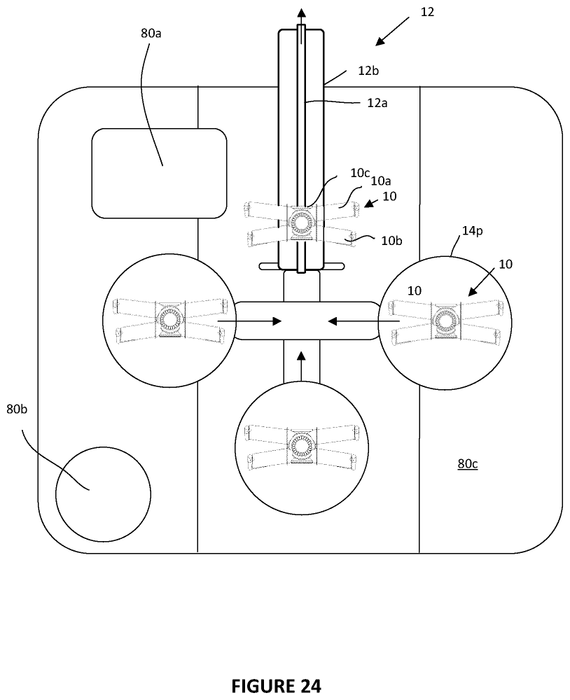

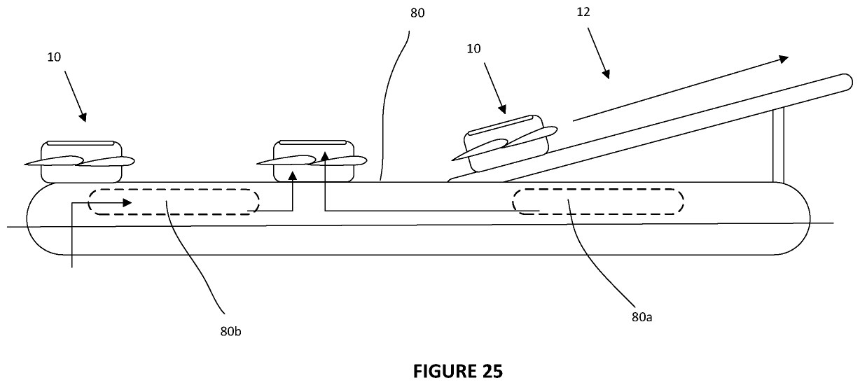

As shown in FIGS. 24 and 25, the FFS may be deployed as a water-based system. In this scenario, a floating vessel such as a barge 80 may be configured with an LLS 12 and support the flight cycles of multiple UAVs 10. Such a system may be appropriate for areas where local conditions cannot provide a sufficiently large area for a land-based deployment or in areas where a permanent/semi-permanent FFS is desired as an emergency response system for that area. The water-based system may be transportable as per various embodiments of a land-based system or as noted may be a permanent or semi-permanent installation.

FIG. 24 is a plan view of water-based system showing deck area 80c supporting 3 landing pads 14p with 3 UAVs and one UAV on the LLS. Various support systems for the barge may be configured including a fuel tank 80a and a water tank 80b. Water tank may not be strictly necessary, to the extent that water may be pumped from the water body but may be required to support filtering of the water to ensure that cleaned water is loaded in a UAV and/or to enable gravity filling. Other support systems including the OCSS may be configured to the vessel or may be part of a land-based OCSS or water-based OCSS on a second barge.

FIG. 25 is a schematic side view of a water-based system showing an inclined LLS as described above and multiple UAVs.

Vessels may be assembled on site/shore from multiple smaller vessels. In one embodiment, the barges are inflatable allowing for more compact stowage/transport to remote areas and assembly/configuration at those areas. Barges may be assembled in sections.

In some situations, the FFS may be configured as a permanent/semi-permanent FFS. For example, a jurisdiction may invest in a FFS that is a permanent or semi-permanent installation similar to a fire station. Such a system may form part of a jurisdiction's overall fire-fighting plan and equipment and, depending on local parameters, be configured adjacent to an existing fire-station. For example, if a fire-station has sufficient land-area and could provide a safe launch zone, the FFS could provide rapid response to fires in a local area and provide delivery of water to a residential/commercial building or industrial fire more rapidly than fire trucks.

That is, upon receiving a fire alarm and pin-pointing location, simultaneously with the deployment of fire trucks, a swarm of UAVs could be launched to the fire and, if appropriate, immediately begin attacking the fire via aerial assault whilst fire trucks are still enroute to the fire and/or setting up.

Safety considerations for an urban deployment may require additional features such as parachutes and sirens as described above.

1.-30. (canceled)

31. An unmanned aerial vehicle (UAV) system, the UAV system having a UAV comprising:
a fuselage;
4 wings configured to the fuselage;
a thrust propulsion system including a wing tip nozzle (WTN) configured to a wing tip of each wing, each WTN rotatable between a horizontal thrust position and a vertical thrust position;
at least one engine configured to the fuselage, the engine having a rotor configured to draw air through a stator and into the fuselage;
a wing duct configured to each wing to direct air within the fuselage to each WTN;
a throttle system configured within each wing duct to control flow of air through each wing;
a payload system configured to the fuselage and to hold a payload;
a UAV control system configured to each WTN and the throttle system and configured to control flow of air through each wing and orient each WTN.

32. The UAV system as in claim 31 wherein the UAV and UAV control system are configured for horizontal/inclined take-off, horizontal flight and vertical landing.

33. The UAV system as in claim 32 wherein the UAV control system is configured to independently control the flow of air through each wing and independently orient each WTN.

34. The UAV system as in claim 31 where the payload system is a tank configured to hold a liquid payload.

35. The UAV system as in claim 31 wherein the payload system has a dump valve configured to the UAV control system to enable rapid release of the payload.

36. The UAV system as in claim 31 wherein the payload system is configured to hold a total mass of liquid payload 2-4 times the mass of the UAV without the payload.

37. The UAV system as in claim 31 wherein the at least one engine is a turbine engine.

38. The UAV system as in claim 31 wherein each wing tip nozzle includes a wing tip actuator configured to independently rotate and control an orientation of each wing tip nozzle.

39. The UAV system as in claim 31 wherein the UAV control system is configured for semi-autonomous control of the UAV.

40. The UAV system as in claim 39 wherein the UAV control system is configured for multiple phases of flight including:
take-off phase flight where the UAV control system is configured to orient the thrust propulsion system to a take-off configuration and provide take-off thrust to the thrust propulsion system;
climb phase flight where the UAV control system is configured to orient the thrust propulsion system to a climb configuration and maintain climb phase thrust and climb phase pitch, roll and yaw control;
cruise phase flight where the UAV control system is configured to orient the thrust propulsion system to a cruise configuration and maintain cruise phase thrust and cruise phase pitch, roll and yaw control;
descent phase flight where the UAV control system is configured to orient the thrust propulsion system to a descent configuration and maintain phase thrust and descent phase pitch, roll and yaw control;
landing descent phase flight where the UAV control system is configured to orient the thrust propulsion system to a vertical landing configuration and maintain landing phase thrust and landing phase pitch, roll and yaw control to land the UAV vertically.

41. The UAV system as in claim 31 wherein the thrust propulsion system further comprises at least one fuselage mounted nozzle system configured to provide horizontal and vertical thrust.

42. The UAV system as in claim 31 further comprising:
a launch system configured to operatively connect to the UAV during a launch phase, the launch system including at least one rail and acceleration system configured to horizontally accelerate the UAV to a take-off velocity.

43. The UAV system as in claim 42 further comprising an operations control and support system (OCSS), the OCSS including at least one landing pad, a fuel system, a payload loading system, and a flight center wherein the at least one landing pad is configured to enable UAV landing adjacent the launch system, the fuel system is configured to enable UAV fueling on the at least one landing pad, the payload loading system is configured to enable payload loading to the payload system and the flight center is configured to enable an operator to communicate with at least one UAV during UAV launch, flight and landing.

44. The UAV system as in claim 43 further comprising a reconnaissance UAV configured to monitor a geographic area adjacent a deployment area, the reconnaissance UAV configured to collect situational data from above a deployment area and communicate with the operational flight control system to provide situational data to the operational flight control system.

45. The UAV system as in claim 44 wherein situational data includes geographic location and local heat signatures.

46. A fire-fighting system (FFS) for payload delivery to fires comprising:
at least one unmanned aerial vehicle (UAV) having at least two wing pairs configured for horizontal or inclined take-off, horizontal flight, vertical landing and payload delivery;
a launch system configured to detachably couple to a UAV and accelerate the UAV to a launch velocity along a track;
a landing pad adjacent the launch system configured to enable vertical landing of at least one UAV;
a payload loading system configured to the FFS to load a payload to the UAV;
a command system configured to launch a UAV from the launch system, monitor a UAV during flight and land a UAV at the landing pad.

47. The FFS as in claim 46 further comprising a fuel loading system configured to the FFA to refuel a UAV.

48. The system as in claim 47 further comprising a reconnaissance drone configured to fly in area over a fire, monitor the status of the wildfire and provide real-time information to the command system and wherein the command system is further configured to receive real-time data from the reconnaissance drone.

49. An unmanned aerial vehicle (UAV) comprising:
a fuselage;
4 wings configured to the fuselage;
at least two vectored thrust nozzles (VTN) configured to the fuselage, each VTN rotatable between a horizontal thrust position and a vertical thrust position;
at least one engine configured to the fuselage, the engine having a rotor configured to draw air through a stator and into the fuselage;
a duct configured to direct air within the fuselage to each VTN;
a throttle system configured to the duct to control flow of air through each VTN;
a liquid payload system configured to the fuselage; and,
a UAV control system configured to each VTN and the throttle system and configured to control flow of air to each VTN and to release liquid payload from the liquid payload system.

50. The UAV as in claim 49 further comprising at least one wing tip nozzles (WTNs) configured to a wing tip of each wing, each WTN rotatable between a horizontal thrust position and a vertical thrust position.
